(19) United States
(12) Patent Application Publication
(10) Pub. No.: US 2023/0233999 A1
(43) Pub. Date: Jul. 27, 2023

(54) APPARATUS FOR SEPARATING HYDROGEN FROM A GAS MIXTURE AND PROCESS FOR THE PRODUCTION THEREOF

(71) Applicant: Aspens GmbH, Hannover (DE)

(72) Inventors: Lin Bai, Hannover (DE); Simon Pauli, Hannover (DE); Henner Rüschkamp, Hannover (DE)

(73) Assignee: Aspens GmbH, Hannover (DE)

(21) Appl. No.: 17/926,856

(22) PCT Filed: May 27, 2021
(86) PCT No.: PCT/IB2021/054648

§ 371 Date: Nov. 21, 2022

(30) Foreign Application Priority Data
Jun. 5, 2020 (DE) 10 2020 114 998.0

(51) Int. Cl. B01D 63/10; B01D 71/02; B01D 53/22

(52) U.S. Cl. CPC B01D 63/103; B01D 71/0223; B01D 63/101; B01D 53/228; B01D 2313/14; B01D 2257/108; B01D 2313/086

(57) ABSTRACT

The invention relates to an apparatus for separating hydrogen from a gas mixture, comprising a vessel which defines an inlet collection space for the gas mixture and an offtake collection space for hydrogen, where the inlet collection space is separated from the offtake collection space by means of a hydrogen-permeable membrane. The invention is also directed to a process for producing an apparatus for separating hydrogen from a gas mixture, which comprises a hydrogen-permeable membrane, a gas mixture inlet, a hydrogen offtake and a residual gas outlet.

The invention relates to an apparatus for separating hydrogen from a gas mixture, comprising a vessel which defines an inlet collection space for the gas mixture and an offtake collection space for hydrogen, where the inlet collection space is separated from the offtake collection space by means of a hydrogen-permeable membrane. The invention is also directed to a process for producing an apparatus for separating hydrogen from a gas mixture, which comprises a hydrogen-permeable membrane, a gas mixture inlet, a hydrogen offtake and a residual gas outlet.

Hydrogen is becoming increasingly important as storable energy carrier. Thus, it is known that hydrogen can be produced by electrolysis of water by means of electric energy, in particular electric energy derived from wind or solar power, and this can thus be used for storage of surplus solar or wind power. The hydrogen can for this purpose not only be stored in suitable gas tanks but it is also possible to feed it into an existing natural gas network and transport it in this way. It can then either be converted together with the natural gas back into electric energy or can be separated off again from the natural gas in order to be made available for, for example, fuel cells in vehicles. Feeding up to 10% of hydrogen into the natural gas/town gas network is not of any concern in terms of safety. The gas network not only performs a storage function for the hydrogen but also allows the transport thereof to any place in the gas pipeline system at which it can be separated off from the residual gas by means of a suitable hydrogen separation plant and passed to its further use, e.g. for supply to a hydrogen filling station for vehicles.

EP 3 080 038 B1 describes such a method for transporting and storing hydrogen, wherein the hydrogen produced by electrolysis is reacted with synthesis gas to form methane and the methane gas produced in this way is fed into the natural gas network. The amount of natural gas corresponding to the methane introduced is taken off from the gas network at the desired place and decomposed by means of a steam reformer into hydrogen and carbon dioxide in order to make the hydrogen available again, for example for use in a fuel cell.

The recovery of hydrogen from the gas mixture by means of a steam reformer is both complicated from a technical point of view and not optimal in terms of energy considerations. US 2006/0090649 A1 describes a tubular, large-area, inorganic module which is suitable for separation of hydrogen by means of a membrane separation process, which process has a better energy efficiency than other processes and can be operated more easily than such other processes. As membrane material for separation of the hydrogen from the gas mixture, palladium, palladium alloys, zeolites, aluminium, silicon carbide or silicon dioxide are described. The membrane materials mentioned are expensive and/or not available on a large scale.

The problem of separating hydrogen from a gas mixture also frequently occurs in other contexts. For example, DE 10 2010 049 792 B4 describes an apparatus and a process for recovering high-purity hydrogen from a pyrolysis gas, in which the hydrogen is separated off from the gas mixture by means of a semipermeable iron membrane (pure iron/raw iron/ferritic iron). Here too, gas exchange occurs in an apparatus comparable to a tube reactor, which has a plurality of tubes whose tube walls form the membrane. Since hydrogen diffusion through an iron membrane is a factor of from 100 to 1000 lower than in the case of the materials indicated above, e.g. palladium, the exchange area of the iron membrane has to be from 100 to 1000 times greater than that of a palladium membrane in order to separate off a comparably large amount of hydrogen from a gas mixture. This makes known apparatuses having tubular iron membranes very large.

It is an object of the invention to provide an apparatus of the type mentioned at the outset and also a process for the production thereof, by means of which a very large exchange area of the membrane used can be realised in a small construction space.

This object is achieved with the apparatus of the invention by the membrane being arranged in an essentially folded, spiral or helical configuration with a plurality of membrane turns arranged at a spacing in such a way that alternating regions of the inlet collection space and the offtake collection space are formed in the spacing between neighbouring membrane turns. To achieve the object, the inventive process proposes that the membrane be wound spirally around the gas mixture inlet and/or the hydrogen offtake and/or the residual gas outlet in such a way that neighbouring membrane turns are arranged at a spacing from one another and alternating regions of an inlet collection space communicating with the gas mixture inlet and an offtake collection space communicating with the hydrogen offtake are formed between neighbouring membrane turns.

The particular arrangement of the membrane having a folded, spiral or helical configuration with a plurality of membrane turns and alternating regions of the inlet collection space and the offtake collection space respectively formed in between makes it possible to accommodate a very large membrane exchange area in a small space and thus achieve a high separation rate at a relatively small construction size of the separator. Owing to the very compact construction, effective thermal insulation of the apparatus is possible with a comparatively small outlay, so that it is possible to operate the separator at elevated temperatures, which promote the diffusion of hydrogen through the membrane when using iron material as membrane material, with only a small heat loss. The apparatus of the invention is particularly advantageously suitable for separation of hydrogen from a gas mixture which is obtained at temperatures higher than ambient temperature. Such mixtures can be, for example, hot offgases from waste incineration plants, from pyrolysis processes and/or be gases arising in coking processes. A preferred embodiment of the apparatus can be produced quickly and inexpensively by the process of the invention.

In a particularly advantageous embodiment of the apparatus of the invention, the membrane can have two membrane layers which alternate in their folded, spiral or helical arrangement. The offtake collection space for the hydrogen is bounded on both sides by the two membrane layers and the membrane area through which the hydrogen can diffuse from the regions of the gas mixture inlet into the adjacent regions for the offtake of hydrogen is particularly large in this embodiment.

The membrane is preferably provided at least in subregions with spacers, so that the individual membrane layers cannot come into contact with one another, in any case where such spacers are provided, but a sufficiently large volume for passage of the gas mixture or of the hydrogen can be formed in between.

In a particularly advantageous embodiment of the invention, the spacers are formed by embossings distributed over the area of the membrane; in the preferred embodiment having two membrane layers, the spacers are preferably provided on only one of the two membrane layers. However, it is also possible for the spacer to be configured as an insert arranged at least in subregions between the membrane turns.

The membrane preferably consists of an iron material, in particular a pure iron foil or a foil composed of ferritic iron or low-alloy steel having a suitable, very small foil thickness which is preferably less than 0.5 mm. A foil thickness of less than 0.2 mm and very particularly preferably less than 0.1 mm is particularly desirable.

In a particularly advantageous embodiment of the apparatus of the invention, the membrane is arranged as two-layer spiral winding around at least one gas mixture inlet, at least one residual gas outlet and/or at least one hydrogen offtake. For the purposes of the process, the membrane is thus preferably wound in the manner of a double-layer spiral around the gas mixture inlet and/or the hydrogen offtake and/or the residual gas outlet. The arrangement can, in the apparatus of the invention, be arrived at by the gas mixture inlet and/or the hydrogen offtake and/or the residual gas outlet being configured as tube sections arranged centrally in the spiral winding. The membrane is preferably passed through between the gas mixture inlet and the hydrogen offtake and wound up in a double layer around the inlet and the offtake with formation of a spacing between adjacent layers.

The membrane turns can be closed off from one another in a gastight manner at their end-face edges by at least one end face lid or an enveloping layer closed around the circumference or a sealant or adhesive sealing the membrane layers from one another, so that it is in every case ensured that gas exchange between adjacent regions of the gas mixture inlet and of the hydrogen offtake occurs only through the membrane layers located in between. The circumferentially closed enveloping layer can, in an advantageous embodiment of the invention, be realised, for example, by a wire or a narrow metal strip having a diameter or a thickness which corresponds to the spacing which the membrane layers (are to) have from one another being arranged between the individual layers of the membrane at their circumferential edges. The diameter of the wire or the thickness of the metal strip thus preferably corresponds to the corresponding dimension of the spacer. This wire or metal strip is then soldered, adhesively bonded or joined in another suitable way in a gastight manner to the membrane layers at the edge thereof.

The inlet collection space advantageously has a residual gas outlet which is preferably arranged at a greatest possible distance from the gas mixture inlet of the inlet collection space, so that the gas mixture from which the hydrogen is separated flows past the membrane over the total effective length thereof until it is taken off through the residual gas outlet.

In an advantageous embodiment of the production process of the invention, the membrane is fed as two separate membrane layers which are arranged alternately in the spiral to the apparatus by two stock reels, which then form the double-layer arrangement of the membrane in the apparatus. The membrane or at least one of its membrane layers is preferably provided on its upper side and/or its underside with embossing forming a spacer before the winding operation, so as to ensure that when the membrane is wound up the membrane turns arising are kept at a spacing through which the gas can flow. It is particularly advantageous for embossing to be effected by means of an embossing station arranged between a stock reel and a winding station for winding up the membrane, so that the embossing is produced in the membrane (only) immediately before the membrane is wound up.

The two membrane layers are preferably formed by a one-piece membrane material strip which is passed through in the centre of the double-layer spiral of the apparatus between the gas mixture inlet and the hydrogen offtake in order to delineate the communicating collection spaces from one another.

Further features and advantages of the invention may be derived from the following description and the drawing, in which preferred embodiments are presented and explained further with the aid of examples. The drawing shows:

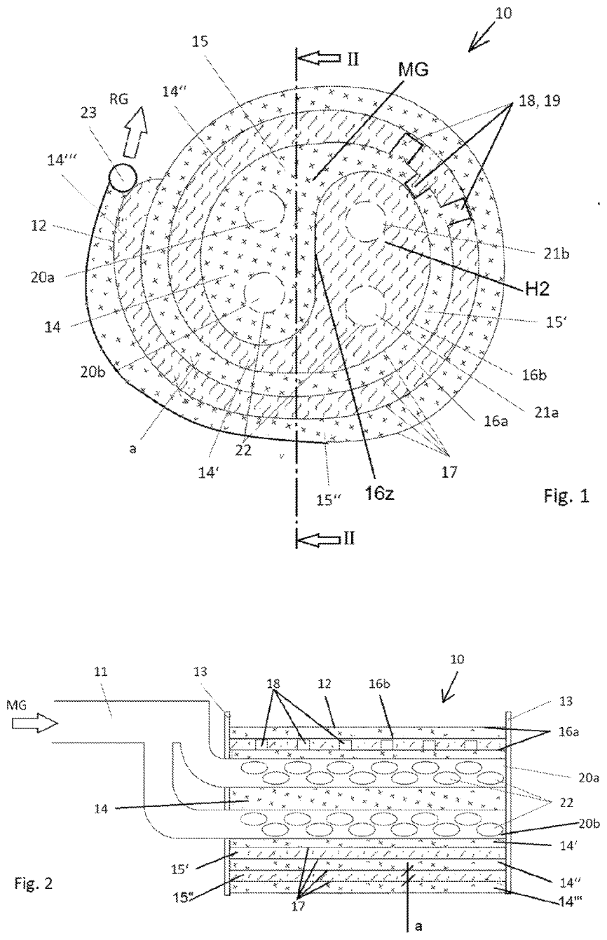

FIG. 1 a schematic depiction of a first embodiment of an apparatus according to the invention for separating hydrogen from a mixed gas in cross section;

FIG. 2 the subject of FIG. 1 in longitudinal section along the line II-II;

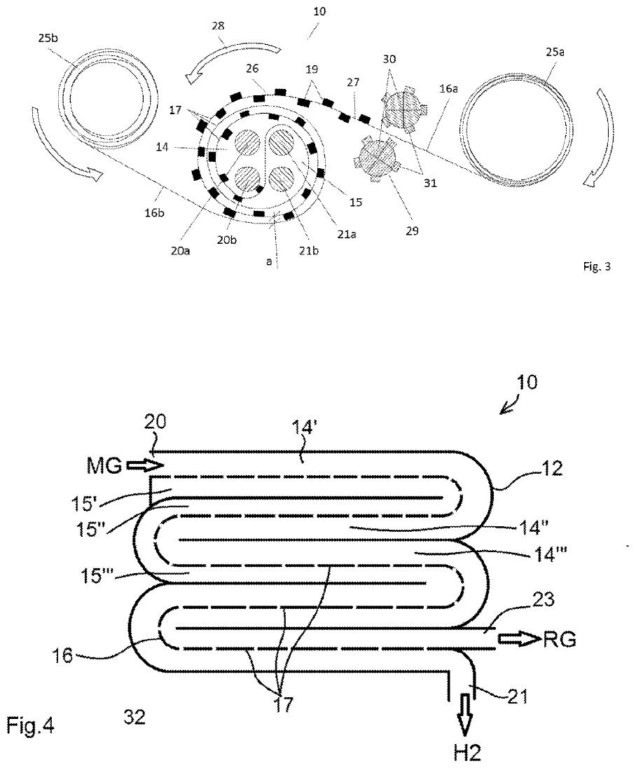

FIG. 3 a simplified depiction of a process according to the invention for producing the apparatus shown in FIGS. 1 and 2;

FIG. 4 a schematic depiction of a second embodiment of an apparatus according to the invention in section.

The drawing shows various embodiments of an apparatus denoted in its totality by 10, which serves to separate hydrogen from a gas mixture again in a membrane separation process, after which it has previously been, for example at a different place, fed into an existing natural gas network for storage and/or transport, of which a mixed gas connection is denoted by 11 in the drawing. Feeding of hydrogen into a natural gas network makes it possible for hydrogen which has been obtained by electrolysis of water by means of electric power from preferably renewable energy sources (wind, solar) to be subjected to temporary storage in the natural gas network without complicated tank technology until use and to be transported together with the natural gas to even a remote point of use. Such a point of use can be, for example, a hydrogen filling station at which vehicles with fuel cell technology can acquire their hydrogen requirement.

In order to separate the hydrogen H2 particularly efficiently from the mixed gas MG consisting of natural gas and hydrogen at the respective point of use, the apparatus 10 according to the invention has, in the first embodiment, an essentially cylindrical vessel 12 which is closed off at its two end faces by end-face lids 13 (FIG. 2). The vessel defines, in its interior, firstly an inlet collection space 14 for the gas mixture MG and secondly an offtake collection space 15 for the hydrogen H2 separated from the gas mixture. Here, the inlet collection space 14 is separated from the offtake collection space 15 by means of a hydrogen-permeable membrane 16. In the preferred embodiments shown here, this consists of a thin foil composed of an iron material, preferably of pure iron or ferritic iron.

In the working example shown in FIGS. 1 to 3, the membrane 16 is made up of two layers and is arranged with an essentially spiral configuration in the vessel 12 with a plurality of membrane turns 17 arranged at a spacing in such a way that alternating regions 14′, 14″, 14′″, etc., of the inlet collection space 14 and regions 15′, 15″, 15′″, etc., of the offtake collection space 15 are formed in the spacing between neighbouring membrane turns 17. The arrangement is configured so that the two membrane layers 16a, 16b of the membrane 16 always alternate from the inside to the outside in their spiral arrangement and the two collection spaces 14 and 15 are accordingly also arranged in a spiral manner around one another.

To prevent the individual layers of the membrane 16 from contacting one another directly over the full area, spacers 18 are provided between the membrane layers 16a, b. These are, when the preferred production process depicted in FIG. 3 is used for the apparatus, provided as embossings 19 (for example in the form of domes) in the one membrane layer 16a which, when the membrane 16 is wound up to create the spiral structure, the adjacent, unembossed membrane layer 16b is kept at a defined spacing corresponding to the height of the embossings, so that it is ensured overall that a sufficiently large space for the flow of gas is present between the membrane turns. Instead of embossings, an insert can be arranged as spacer at least in subregions between the membrane turns, for example a plurality of wires wound up together between the membrane turns 17 or a wire knitted fabric or wire braid which keeps the adjacent membrane layers 16a, b at a spacing from one another.

The membrane 16 arranged as two-layer spiral winding in the embodiment of FIGS. 1 and 2 encloses a gas mixture inlet 20 for the mixed gas MG which opens into its centre and a neighbouring hydrogen offtake 21 separated off by a central section 16z of the membrane. Both the mixed gas inlet 20 and the hydrogen offtake 21 are formed by in each case two tube sections 20a, b or 21a, b which on their circumference are provided with a plurality of openings 22 through which the mixed gas can flow unhindered into the inlet collection space 14 and the hydrogen which has been separated off can be taken off from the offtake collection space 15. The membrane is, as indicated above, passed through between the gas mixture inlet 20 and the hydrogen offtake 21 and wound in a double layer around the inlet 20 and the offtake 21 to form the spacing a between adjacent layers or membrane turns ensured by the spacer.

After the hydrogen H2 has been separated off, a residual gas RG which consists essentially of natural gas and a residual amount of hydrogen which has not diffused through the membrane in the apparatus and thus been separated off from the mixed gas remains in the inlet collection space. In order to discharge this residual gas RG, a residual gas collection tube 23 is provided at the radially outer end of the spiral and thus at a position on the inlet collection space 14 which is farthest removed from the gas mixture inlet 20 in the centre of the apparatus, between the cylindrical outer wall of the vessel 12, which bounds the inlet collection space on the outside, and the outermost membrane layer which ends there. The residual gas collection tube 23 has similar openings (not shown) as the two tube sections 20, 21 in the region of its circumferential wall which faces the collection space 14, so that the residual gas RG can flow through these openings into the collection tube 23 and be discharged.

The individual membrane turns 17 are joined at their end-face edges 24 to the two end-face lids 13 of the vessel 12 in a gastight manner, so that the different regions of the inlet collection space 14 and of the offtake collection space 15 do not communicate with one another here, either. The gastight connection can, for example, be ensured reliably by the end-face lids 13 consisting of a curable, initially liquid sealing or embedding composition or being coated on the inside with such a composition; at least one piece of the wound-up construction made up of the membrane layers and the outer vessel wall is dipped into this embedding composition until the embedding composition has cured and encloses the end-face edges of the membrane turns tightly.

FIG. 3 schematically illustrates the main process steps of the particularly advantageous production process of the invention for the embodiment of the separator apparatus shown in FIGS. 2 and 3. As can be seen, the membrane 16 is supplied from two stock reels 25a, b, with the part supplied from the first reel 25a forming the first membrane layer 16a and the part of the membrane 16 supplied from the second reel 25b forming the second membrane layer 16b in the wound-up arrangement in the apparatus 10. Here, the membrane 16 is passed through in the centre of the double-layer spiral of the apparatus 10 between the gas mixture inlet 20 and the hydrogen offtake 21, i.e. the two membrane layers 16a, b go over into one another in one piece there. The two membrane layers are thus formed by a one-piece membrane material strip which is passed through between gas mixture inlet 20 and hydrogen offtake 21 in order to delineate the communicating collection spaces 14 and 15 from one another.

Immediately before the membrane is wound up by turning the tube sections 20a, b and 21a, b forming the inlet and the offtake around one another, the first of the two membrane layers 16a is provided on its upper side 26 and its underside 27 with the embossings 19 forming the spacers 18. For this purpose, an embossing station 29 is arranged between the stock reel 25a and a winding station, indicated only by the rotational direction arrow 28, for winding up the membrane 16. The embossing station has two rotatably arranged embossing rollers 30 which on their circumferential surface bear a plurality of distributed embossing cams 31 which produce the embossings 19 in the membrane layer 16a while the latter runs through between the two embossing rollers. As can readily be seen in the drawing, the embossings 19 projecting at a uniform height from the underside 27 and the upper side 26 of the membrane layer 16 ensure that, in the wound state in the apparatus, the inbetween parts of the second membrane layer 16b contacts the first membrane layer only at the projecting regions of the embossings and otherwise maintains a spacing a from the first membrane layer, which spacing corresponds to the height of the embossings.

FIG. 4 schematically shows an alternative embodiment of the apparatus 10 of the invention, in which the membrane 16 is not wound but instead has a folded arrangement. The neighbouring membrane turns 17 extending from right to left and in the opposite direction in the folded arrangement in the drawing are accommodated in a vessel 12 which in its interior is provided with a plurality of dividing walls 32 which alternately extend from left and from right in parallel between adjacent membrane turns 17 to just before a turning point of these, so that an arrangement comparable to a tightly laid serpentine tube which is divided in its interior by the membrane into the two collection spaces 14 and 15 is obtained on average. Just as in the first embodiment, a very large membrane area can in this arrangement, too, be accommodated in a small construction space and high separation rates can thus be realised for a compact arrangement of the apparatus.

The apparatus of the invention and the process according to the invention are not restricted to the above-described purpose of separation of hydrogen from a mixture with natural gas. The apparatus is also very well-suited for separating hydrogen from a hot gas mixture which contains the hydrogen and arises at elevated temperatures which are, for example, above 400° C. and can be up to 700° C. Examples of such applications are offgases from coking processes, from thermal cracking of wastes, from pyrolysis plants and the like. A membrane composed of an iron material, e.g. a membrane composed of pure iron, of ferritic steel or a low-alloy steel, is very suitable for, in particular, applications in which the mixed gas fed to the apparatus is at a comparatively high temperature. Such a membrane composed of iron material has a better permeability for hydrogen at the higher operating temperatures compared to that at ambient temperature, i.e. a significantly greater degree of separation can be achieved than at ambient temperature for the same membrane area.

1. An apparatus for separating hydrogen from a gas mixture, comprising a vessel which defines an inlet collection space for the gas mixture and an offtake collection space for hydrogen, where the inlet collection space is separated from the offtake collection space via a hydrogen-permeable membrane, wherein the membrane is arranged with an essentially folded, spiral or helical configuration with a plurality of membrane turns arranged at a spacing in such a way that alternating regions of the inlet collection space and of the offtake collection space are formed in the spacing between neighbouring membrane turns.

2. The apparatus according to claim 1, wherein the membrane has two membrane layers which alternate with one another in their spiral or helical arrangement.

3. The apparatus according to claim 1, wherein the membrane is provided at least in subregions with spacers.

4. The apparatus according to claim 3, wherein the spacers are formed by embossings distributed over the area of the membrane.

5. The apparatus according to claim 3, wherein the spacers are provided on only one of the two membrane layers.

6. The apparatus according to claim 3, wherein the spacers are configured as at least one insert arranged at least in subregions between the membrane turns.

7. The apparatus according to claim 1, wherein the membrane consists of an iron material.

8. The apparatus according to claim 1, wherein the membrane is arranged as two-layer spiral winding around at least one gas mixture inlet, at least one residual gas outlet and/or at least one hydrogen offtake.

9. The apparatus according to claim 8, wherein the gas mixture inlet and/or the hydrogen offtake and/or the residual gas outlet is/are configured as tube sections arranged in the spiral winding.

10. The apparatus according to claim 8, wherein the membrane has been passed between the gas mixture and the hydrogen offtake and wound in two layers around the inlet and the offtake to form a spacing between adjacent layers.

11. The apparatus according to claim 1, wherein the membrane turns are closed off from one another in a gastight manner at their end-face edges by at least one end face lid or an enveloping layer closed around its circumference and/or a sealant or adhesive which seals the membrane layers from one another.

12. The apparatus according to claim 1, wherein that the inlet collection space has a residual gas outlet which is preferably arranged at a greatest possible distance from the gas mixture inlet of the inlet collection space.

13. A process for producing an apparatus for separating hydrogen from a gas mixture, which apparatus comprises a hydrogen-permeable membrane, a gas mixture inlet, a hydrogen offtake and a residual gas offtake, wherein the membrane is wound spirally around the gas mixture inlet and/or the hydrogen offtake and/or the residual gas outlet in such a way that neighbouring membrane turns are arranged at a spacing from one another and alternating regions of an inlet collection space communicating with the gas mixture inlet and an offtake collection space communicating with the hydrogen offtake are formed between neighbouring membrane turns.

14. The process according to claim 13, wherein the membrane is wound in the manner of a double-layer spiral around the gas mixture inlet and/or the hydrogen offtake and/or the residual gas outlet.

15. The process according to claim 14, wherein the membrane is fed as two separate membrane layers which are arranged alternately in the spiral to the apparatus by two stock reels.

16. The process according to claim 13, wherein the membrane or at least one of its membrane layers is provided with embossing forming a spacer on its upper side and/or its underside before the winding operation.

17. The process according to claim 16, wherein embossing is effected by means of via an embossing station arranged between a stock reel and a winding station for winding up the membrane.

18. The process according to claim 15, wherein the two membrane layers are formed by a one-piece membrane material strip which is passed through in the centre of the double-layer spiral of the apparatus between the gas mixture inlet and the hydrogen offtake in order to delineate the communicating collection spaces from one another.
